(19) United States
(12) Patent Application Publication
(10) Pub. No.: US 2009/0160200 A1
(43) Pub. Date: Jun. 25, 2009

(54) LOCKING ASSEMBLY FOR SHUTTERS

(76) Inventors: Nathan D. Greenway, Attica, MI (US); Brad A. Kutler, Oxford, MI (US); Clyde G. Allen, Columbiaville, MI (US)

Correspondence Address: JEFFREY A. SADOWSKI, ESQ.;HOWARD & HOWARD ATTORNEYS, P.C., Suite 101, The Pinchurst Office Center, 39400 Woodward Avenue, Bloomfield Hills, MI, 48304-5151, US

(21) Appl. No.: 12/339,399

(22) Filed: Dec. 19, 2008

Related U.S. Application Data
(60) Provisional application No. 61/015,980, filed on Dec. 21, 2007.

(51) Int. Cl. E05C 19/00

(52) U.S. Cl. 292/268; 292/275

(57) ABSTRACT

A locking assembly for retaining a pair of shutters in a closed position on a dwelling, including an elongate backing bracket adapted to be fixedly mounted to the dwelling, the backing bracket including a pair of support portions extending laterally relative to the length of the backing bracket, and an outer locking portion. The shutters in their closed position are in abutting contact with the support portions, the outer locking portion extends through a gap defined between adjacent edges of the closed pair of shutters. The locking assembly further includes an elongate retention bracket having a channel in which the outer locking portion is received, and a pair of retention portions extending laterally relative to the length of the retention bracket, the outer locking portion adapted to be secured to the retention bracket within the channel. The adjacent edges of the closed pair of shutters are captured between the support portions and the retention portions, retaining the pair of shutters in a closed position.

### CROSS-REFERENCE TO RELATED APPLICATION

The instant application claims priority to U.S. Provisional Patent Application Ser. No. 61/015,980, filed Dec. 21, 2007, the entire specification of which is expressly incorporated herein by reference.

### FIELD OF THE INVENTION

The subject invention generally relates to shutter assemblies. More specifically, the subject invention relates to reinforced, locking, shutter assemblies that withstand inclement weather, and more particularly to a locking assembly for shutters.

### BACKGROUND OF THE INVENTION

Various locking assemblies for shutters are known in the art. It is generally known that locking assemblies are utilized, when necessary, to lock pairs of shutters in a closed position on a dwelling. Shutters are used for both aesthetic and functional purposes on the dwelling. In the closed position, the shutters function to protect windows, doors, and other openings of the dwelling during inclement weather, such as precipitation storms, wind storms, and hurricanes.

During such inclement weather, it is pertinent to lock, or retain, the shutters in the closed position such that the shutters can continue to provide adequate protection to the windows, doors, and other openings during and throughout the inclement weather. If the weather causes the shutters to open then the functional purpose of the shutters is defeated.

Conventional assemblies for locking pairs of shutters in the closed position do not adequately retain the shutters in the closed position throughout the inclement weather. In these assemblies, wind either bends or breaks the assembly causing the shutters to open. Also, many conventional locking assemblies require excessive modification and direct drilling into and through the shutters to adequately retain the shutters in the closed position. In these assemblies fasteners extend through at least portions of the shutters. As a result and to a varying degree, these conventional locking assemblies damage the shutters such that, after the inclement weather, the aesthetic purpose of the shutters is negatively impacted.

Furthermore, some conventional locking assemblies, also referred to in the art as storm or locking bars, create an emergency egress issue that prevents occupants of the dwelling from escaping during an emergency, such as a fire. More specifically, a conventional storm bar is mounted across the shutters once the shutters have been closed. The storm bar is secured, typically screwed, into the exterior of the dwelling on each side of the closed shutters to prevent the shutters from opening during the inclement weather. Screws are also used to connect the shutters to the storm bar such that the shutters can not be blown or otherwise deflected inward, i.e., toward the dwelling, during the inclement weather. With the storm bar screwed to the dwelling and the shutter screwed to the storm bar, the occupants of the dwelling cannot open a window or door from within the dwelling to release the storm bar and escape. In some other conventional locking assemblies, their installation to the dwelling is cumbersome.

Due to the deficiencies in the locking assemblies of the prior art, including those described above, it is desirable to provide a novel locking assembly for shutters that adequately retains the shutters in a closed position on a dwelling such that protection to a window, door, or other opening is maximized throughout any inclement weather. It is also desirable to provide a locking assembly for shutters that can easily be unlocked and opened from either side and when unlocked is clear of the opening.

The present invention thus provides a locking assembly for retaining a pair of shutters in a closed position on a dwelling. The locking assembly includes an elongate backing bracket adapted to be fixedly mounted to the dwelling. The backing bracket includes a pair of support portions extending laterally relative to the length of the backing bracket, and an outer locking portion, the pair of shutters in their closed position in abutting contact with the support portions, the outer locking portion extending through a gap defined between adjacent edges of the closed pair of shutters. The locking assembly further includes an elongate retention bracket having a channel in which the outer locking portion is received, and a pair of retention portions extending laterally relative to the length of the retention bracket, the outer locking portion adapted to be secured to the retention bracket within the channel. The adjacent edges of the closed pair of shutters are captured between the support portions and the retention portions, retaining the pair of shutters in a closed position.

The present invention also provides a locking assembly for retaining a pair of shutters in a closed position over an opening of a dwelling that includes a backing bracket having an exteriorly-directed outer locking flange and a pair of substantially coplanar support flanges, the outer locking flange extending perpendicularly from between the pair of support flanges, and extending through a gap between adjacent substantially vertical edges of the closed pair of shutters and projecting beyond their exterior, substantially vertical surfaces. The backing bracket is secured to the dwelling. The locking assembly further includes a retention bracket disposed over the gap and comprising a channel formed by a pair of spaced, substantially vertical walls, the walls being substantially parallel to each other, and a pair of substantially coplanar retention flanges, a retention flange extending laterally outwardly from the channel from the end of each of the pair of channel walls. The support flanges and the retention flanges are substantially parallel when the locking assembly is locked, portions of the shutters proximal to the gap being captured therebetween. The portion of the outer locking flange projecting beyond the exterior surfaces of the closed shutters is disposed within the channel.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a dwelling illustrating a first pair of shutters in an open position, and a second pair of shutters in a closed position and locked with a locking assembly according to a first embodiment of the present invention;

FIG. 2 is a top partial perspective view of a retention bracket of the locking assembly of FIG. 1;

FIG. 3 is a top partial perspective view of a backing bracket of the locking assembly of FIG. 1;

FIG. 4 is an interior view of a window with its shutters closed and its locking assembly of FIG. 1 shown;

FIG. 5 is an exterior exploded perspective view of the pair of shutters and the locking assembly of FIG. 1;

FIG. 6 is an interior, partial perspective view of a window with its shutters closed and positioned against the backing bracket of the locking assembly of FIG. 1;

FIG. 7 is a top perspective view of a base of the locking assembly of FIG. 1;

FIG. 8 is an interior, fragmented perspective view of the window shown in FIG. 6, its shutters closed, and its locking assembly in its locked state;

FIG. 9 is a fragmented perspective view of a sill of the dwelling illustrating threaded inserts and fasteners that retain the base of the locking assembly of FIG. 1 thereto;

FIG. 10 is an exterior side perspective partial view of a pair of closed shutters locked with a second embodiment of a locking assembly according to the present invention;

FIG. 11 is another, wider view of the shutters and locking assembly shown in FIG. 10; and

FIG. 12 is an interior perspective partial view of the shutters and locking assembly shown in FIG. 10, the dwelling shown in ghosted lines.

While the invention is susceptible to various modifications and alternative forms, specific embodiments thereof are shown by way of example in the drawings and may herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

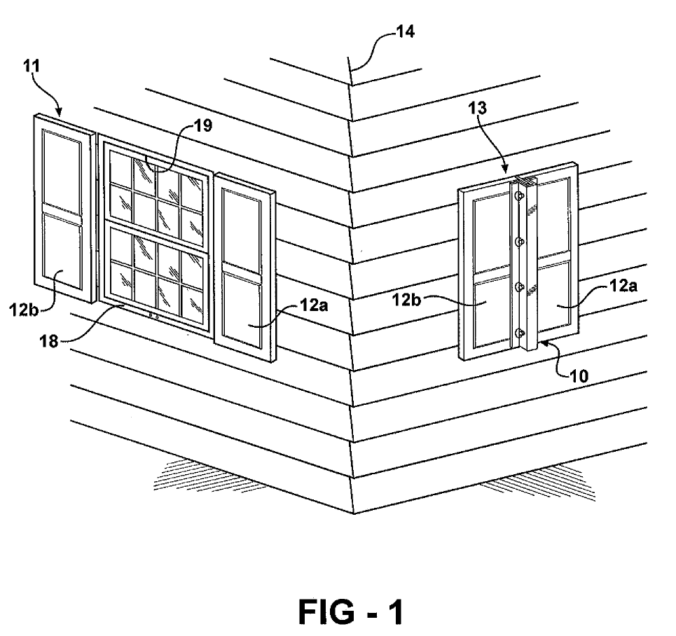

Turning now to the drawings, it is noted that the Figures are not drawn to scale. In particular, the scale of some of the elements of the figures is greatly exaggerated to emphasize characteristics of the elements. It is also noted that the Figures are not drawn to the same scale. Elements shown in more than one Figure that may be similarly configured have been indicated using the same reference numerals. Referring to FIGS. 1-9, wherein like numerals indicate like or corresponding parts throughout the several views, locking assembly 10 according to a first preferred embodiment is shown. Locking assembly 10 locks a pair of shutters 12 in a closed position on dwelling 14. The closed shutters cover and protect a window, door . . . etc. . . . in an opening of dwelling 14 from storm damage. In the Figures, the right hand shutter (viewed from the exterior of the dwelling) is identified as 12a, and the left hand shutter as 12b. In FIG. 1, shutters 12 are shown in open position 11 and closed position 13.

Shutters 12 may be storm shutters, i.e., storm-proof or storm-rated shutters, but locking assembly 10 may also be utilized with any other type of shutter to lock the shutters in their closed position 13. For example, locking assembly 10 may be utilized with aluminum or wood shutters 12 that are not storm shutters.

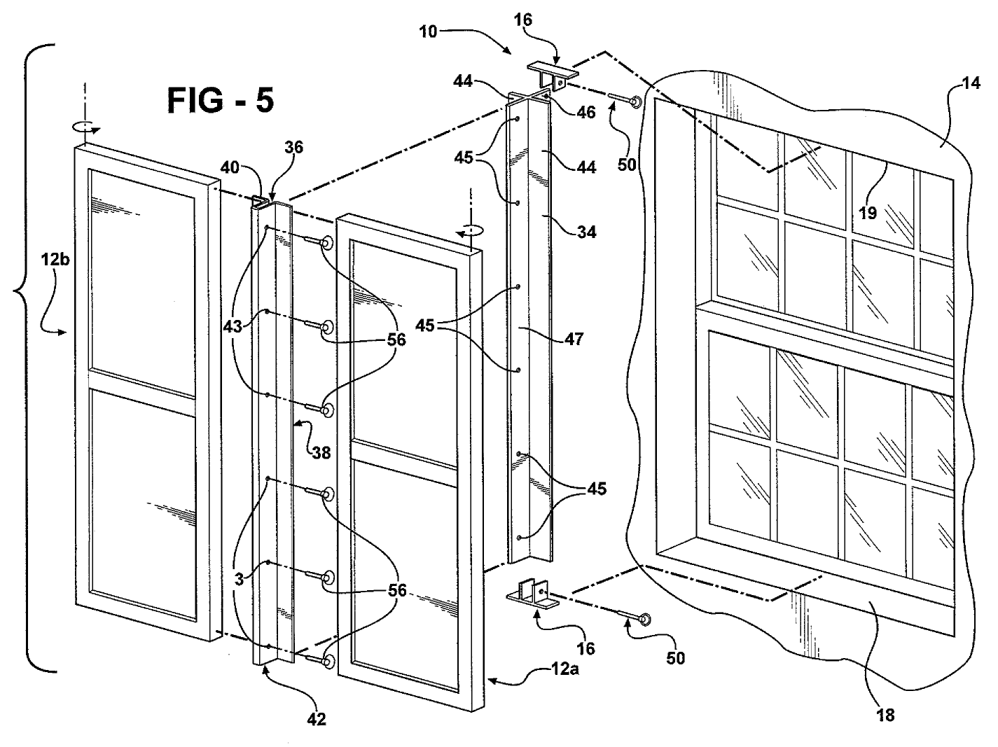

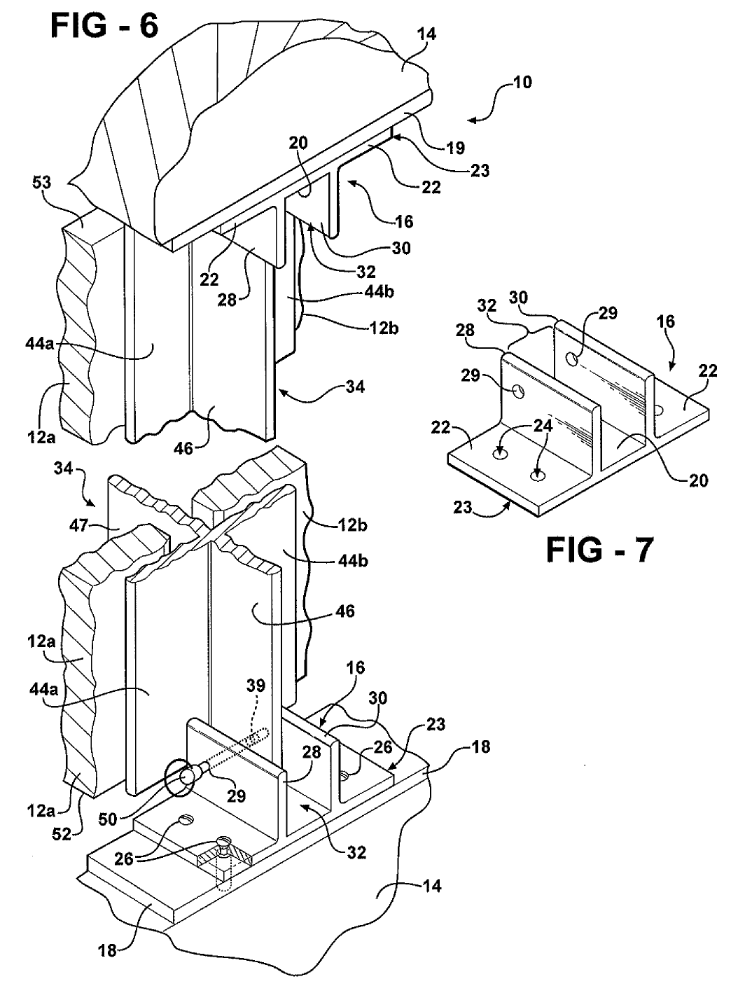

Referring to FIGS. 5-8, locking assembly 10 includes base 16 that is adapted to be mounted to either a window sill 18 or header 19. Although locking assembly 10 may be attached to the dwelling through only a single base 16, it is preferred that locking assembly 10 for each window be attached to the dwelling through a pair of bases 16, one located at a bottom end 52 of shutters 12 (on sill 18) and one located at a top end 53 of shutters 12 (on header 19). FIG. 6 shows a first base 16 mounted to sill 18 and an identical second base 16 mounted to header 19.

Base 16 includes central portion 20 and flange portions 22 flanking central portion 20. Central portion 20 and flange portions 22 lie in a plane, and together form base foot 23 that abuts sill 18 or header 19. Base flange portions 22 include clearance holes 24 for receiving base fasteners 26, such as a nails, screws, bolts, or the like, with which to mount first base 16 to one of sill 18 and header 19.

If included, second base 16 is adapted to be mounted to the other of sill 18 and header 19. That is, if first base 16 is mounted to sill 18, then second base 16 is mounted to header 19, and vice versa.

Preferably, threaded inserts 25 are disposed in sill 18 and/or header 19, as shown in FIG. 9. Threaded inserts 25 have internal threads 27 for threadably receiving and retaining base fasteners 26, such as ¼-20×1 inch pan head screws. Base 16 is attached to sill 18 and/or header 19 by inserting base fasteners 26 through clearance holes 24 and threading them into their respective threaded inserts 25. When locking assembly 10 is removed from dwelling 14, its bases 16 are removed, and base fasteners 26 are rethreaded into threaded inserts 25 for storage until locking assembly 10 is reassembled to dwelling 14.

Although one preferred embodiment of the subject invention includes a first base 16 mounted to sill 18 and a second base 16 mounted to header 19, locking assembly 10 may be described hereinbelow in terms of an embodiment including only one base 16 associated with only one of sill 18 and header 19.

Base 16 further includes first support leg 28 and second support leg 30. As shown in FIG. 7, first and second support legs 28, 30 extend in parallel, perpendicularly from planar foot 23 of base 16. First and second support legs 28, 30 are laterally spaced from one another to define gap 32 located therebetween, and over central portion 20 of foot 23. Axially aligned apertures 29, or detents therefor marking their drilling locations, are provided in support legs 28, 30. A fastener extends through these holes as described further hereinbelow.

Although it is not required, a preferred embodiment of base 16 has first and second support legs 28, 30 and foot 23 being integrally formed. That is, base 16, including its foot 23 and first and second support legs 28, 30 are all one component, and may be, for example, an aluminum extrusion, or stamped sheet metal strip. Alternatively, first and second support legs 28, 30 could be separate components that are not integrated with foot 23, or into a base 16. Thus, support legs 28, 30 may be connected to sill 18 and/or header 19 either directly, or indirectly through foot 23 of base 16.

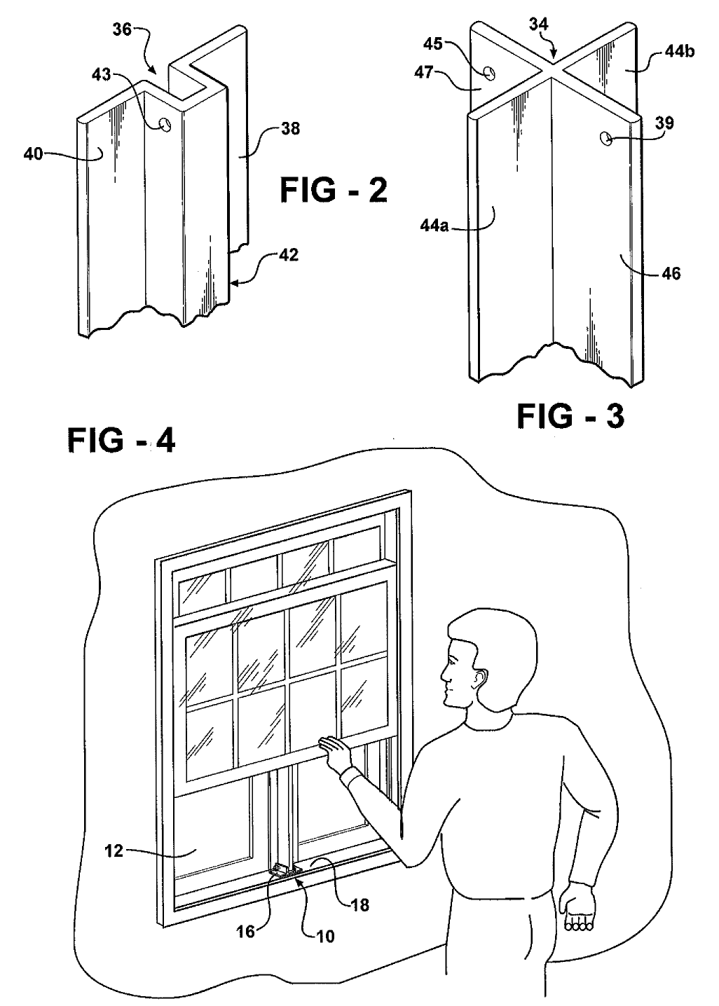

Referring now to FIGS. 3, 5, 6, and 8, locking assembly 10 further includes backing bracket 34 having four flanges forming a generally X-shaped cross-section. With locking assembly 10 installed, interiorly-directed inner locking flange or inner locking portion 46 of backing bracket 34 is at least partially disposed in base gap 32. Coplanar lateral flanges of backing bracket 34 extend from their intersection with inner locking flange 46, to form right 44a and left 44a (as view exteriorly) support flanges or portions. An exteriorly-directed flange, coplanar with inner locking flange 46, and extending from its intersection with support flanges 44, forms outer locking flange or outer locking portion 47 of backing bracket 34. Inner and outer locking portions or flanges 46, 47 extend transversely from laterally extending support portions 44 in opposite directions to form the X-shaped cross-section of backing bracket 34. With backing bracket 34 secured to base(s) 16, and shutters 12a, 12b in their closed position 13, during or after assembly of locking assembly 10, outer locking flange or portion 47 of backing bracket 34 extends through shutter gap 48 defined between the adjacent vertical edges of closed shutters 12. Additionally, the interiorly-facing surfaces of closed shutters 12 adjacent to shutter gap 48 rest against and abut support flanges or portions 44. Backing bracket 34 is preferably an aluminum extrusion.

The length of backing bracket 34 may be initially determined with bases 16 installed onto sill 18 and header 19. Variations in height between the sill and header can thus be accommodated by cutting backing bracket 34 to finished length so that its inner locking flange 46 extends between the opposed base central portions 20 and slidably fits in support gaps 32 between base support legs 28, 29. Alternatively, two separate backing brackets 34 (one secured to sill 18, the other secured to header 19) may be used, having a combined length less than the distance between the sill and the header. As noted above, first and second support legs 28, 30 of base 16 include aligned apertures 29 (FIG. 7). Backing bracket inner locking flange or portion 46 includes apertures 39 which, when inner locking portion 46 is inserted into gap 32, become aligned with base holes 29. Holes 39 of backing bracket 34 may be preexisting or drilled in flange 46 with bracket 34 held in place in bases 16. Holes 39 may be drilled contemporaneously with holes 29 of base 16, if holes 29 are not preexisting.

Once inner locking portion 46 has been placed in bases 16, and holes 29 and 39 aligned, fastener 50 is inserted through aligned holes 29 and 39 to secure backing bracket 34 to base(s) 16. It is preferred that fastener 50 be an elongate locking pin, such as a cotter pin, or a detent pin such as a 5/16 inch Faspin® manufactured by Aerofast, Inc.® of Carol Stream, Ill., USA. However, any other suitable type of fastener may also be used.

Referring now to FIGS. 2, 5, 6, and 8, locking assembly 10 further includes retention bracket 42 having generally U-shaped locking channel 36, and laterally extending, backspaced and coplanar first and second lateral retention flanges or portions 38 and 40 each joined to one leg or wall of U-shaped channel 36. The exposed edge of outer locking flange or portion 47 of backing bracket 34, which extends exteriorly through gap 48 between closed shutters 12, is received in locking channel 36, thereby capturing portions of the shutters adjacent gap 48 between support portions 44 of backing bracket 34 and first and second retention flanges 38 and 40 of retention bracket 42. Retention bracket 42 may be an aluminum extrusion or formed from sheet metal. The length of retention bracket 42 may be cut to length to match that of backing bracket 34, or simply to match the height of shutters 12.

The two legs of U-shaped locking channel 36 are provided with aligned apertures 43. Backing bracket outer locking portion 47 includes apertures 45 which, when the edge of outer locking portion 47 is received in locking channel 36, become aligned with retention bracket holes 43. Holes 43 and 45 may be preexisting, or drilled contemporaneously during initial installation with retention bracket 42 held in position relative to backing bracket 34.

Sets of aligned holes 43 and 45 are located near sill 18 and header 19. Thus, locking assembly 10 locks bottom end 52 of shutters 12 adjacent sill 18 and top end 53 of shutters 12 adjacent header 19. To provide additional, intermediate locking support more toward middle portion 54 of shutters 12, locking assembly 10 may there include a third set of aligned holes 43, 45 and its fastener, or any desired number of additional sets of such apertures 43, 45 and fasteners.

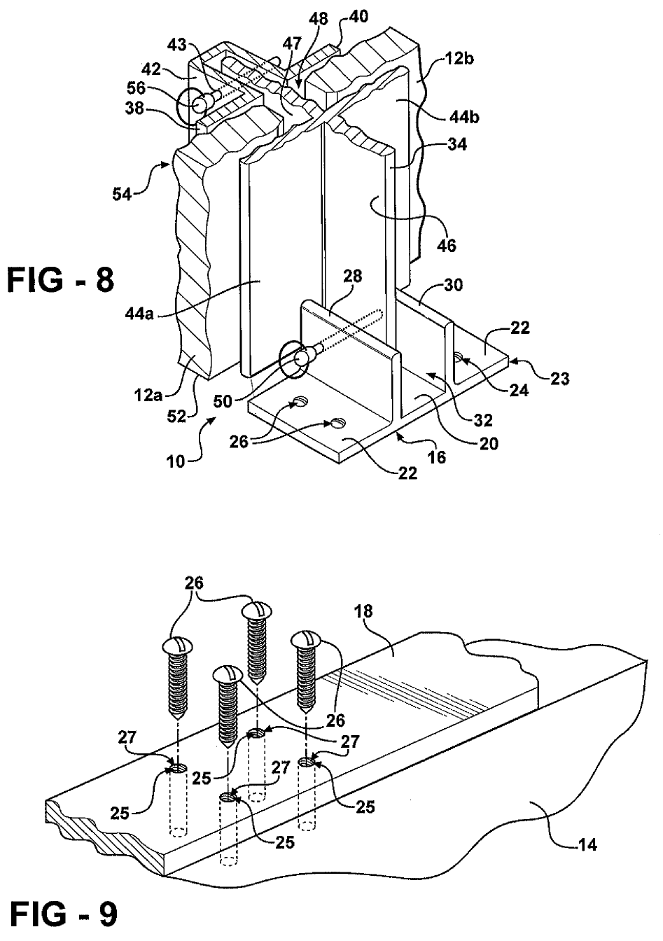

A fastener 56 is inserted through each set of aligned holes 43 and 45 to secure retention bracket 42 to backing bracket 34. It is preferred that fastener 56 be an elongate locking pin, such as a cotter pin, or a detent pin such as a 5/16 inch Faspin® manufactured by Aerofast, Inc.® of Carol Stream, Ill., USA. However, any other suitable type of fastener may also be used. Notably, fastener 56 does not extend through shutters 12, but rather extends through retention bracket 42 and outer locking portion 47 of backing bracket 34, as shown in FIG. 8.

During inclement weather, first and second lateral retention flanges or portions 38, 40 prevent shutters 12 from moving away from sill and/or header 18, 19 and dwelling 14 by keeping the shutters closed and disposed against support flanges or portions 44a, 44b of backing bracket 34.

In preparation for inclement weather, a user of locking assembly 10 preferably mounts first base 16 to sill 18 and second base 16 to header 19, inserting screws 26 through apertures 24 in the flange portions 22 of bases 16 and threading screws 26 into sill 18 and header 19. The sill and header may be provided with threaded inserts 25, as described above, into which screws 26 are received, or the base(s) may be secured to the sill and/or header with screws driven directly into the sill or header material using techniques known to those of ordinary skilled in the art, such as with a drill.

With bases 16 now installed, inner locking flange 46 of backing bracket 34 is next fitted into base gap 32 defined between each base's first and second support legs 28, 30, and secured to bases 16 with a fastener 50 inserted through each set of aligned holes 29, 39. The user may choose to secure one backing bracket 34 to first base 16 at sill 18 for locking bottom end 52 of shutters 12, and another backing bracket 34 to second base 16 at header 19 for additionally locking top end 53 of shutters 12. Preferably, however, a single backing bracket 34 that extends substantially the height of shutters 12 as described above may instead be installed, preferably with its opposite ends secured through inner locking flange 46 to first base 16 at sill 18 and to second base 16 at header 19 with fasteners 50 inserted through aligned holes 29, 39.

With a pair of backing brackets 34, or a single backing bracket 34, secured to bases 16 through inner locking flange(s) 46, the user of locking assembly 10 next closes shutters 12 to rest them against support portions or flanges 44 of each backing bracket 34. As best shown in FIGS. 6 and 8, with shutters 12 in their closed position 13 and abutting support portions 44, outer locking flange or portion 47 of each backing bracket 34 extends through gap 48 between shutters 12 and presents an exposed edge that protrudes through gap 48 and extends beyond the now-exteriorly facing surfaces of closed shutters 12.

Retention bracket 42 is then placed over gap 48, the protruding edge of backing bracket outer locking flange 47 being received into locking channel 36 of retention bracket 42. The portions of shutters 12 adjacent to outer locking portion 47 are now disposed between and captured by backing bracket support portions 44 and retention bracket lateral retention flanges 38, 40.

Next, the user locks locking assembly 10 by installing fasteners 56 through aligned apertures 43, 45 such that each fastener 56 extends through the first wall or leg of U-shaped channel 36, the portion of outer locking flange 47 disposed in channel 36, and the other wall or leg of channel 36. Several sets of aligned apertures 43, 45, each receiving a fastener 56, may be distributed along the length of retention bracket 42 and outer locking flange 47, as shown in FIGS. 1 and 5.

First embodiment locking assembly 10 permits an occupant to unlock the shutters for emergency egress through a shuttered double-hung or inwardly opening window by the occupant opening the window and removing fasteners 50 that secure backing bracket(s) 34 to base(s) 16. Once fasteners 50 (preferably of a type removable without tools) have been removed, backing bracket 34, to which retention bracket 42 is still attached with fasteners 56, can be pushed outwardly, the portions of shutters 12 disposed between support flanges 44 and retention flanges 38, 40, sliding out from therebetween, perhaps with some small deflection of the shutters or the laterally-extending flanges of brackets 34 and/or 42. The attached brackets 34 and 42 may either fall away or remain with only one of now open shutters 12, but the dwelling opening will be clear of the locking device, facilitating easy egress therethrough.

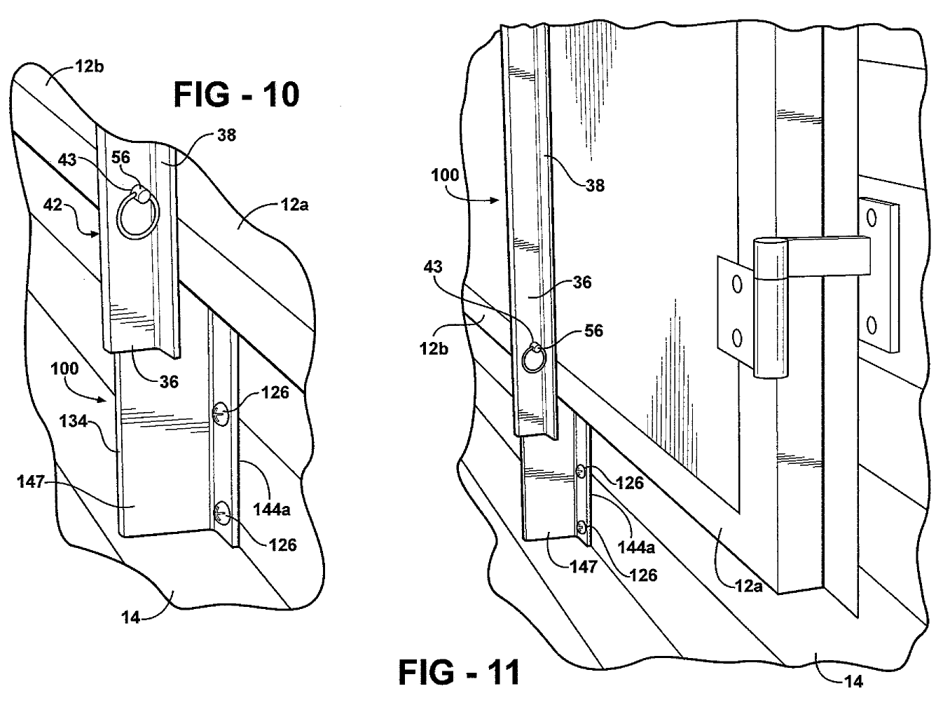

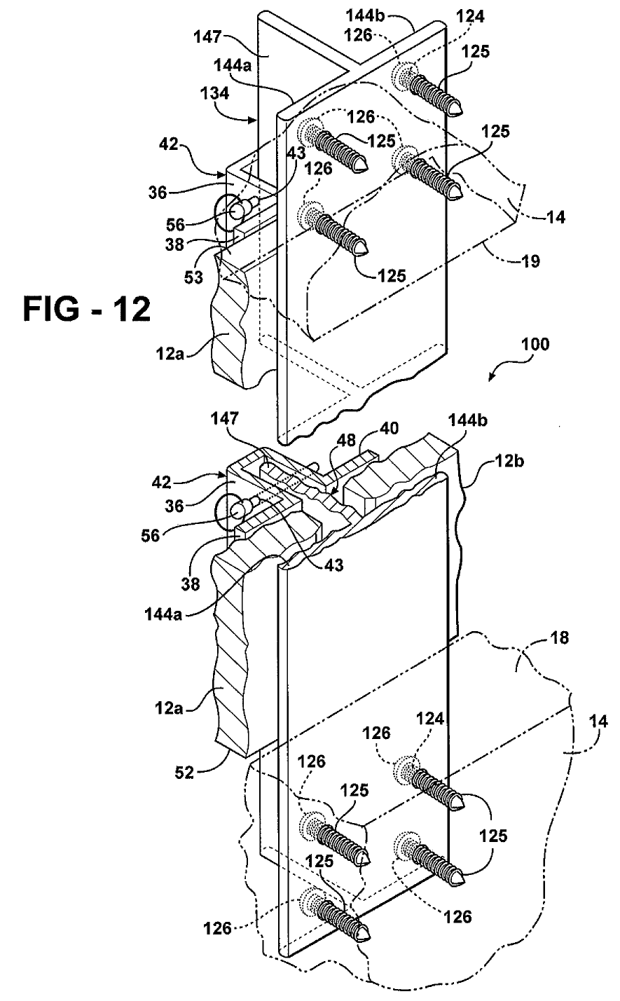

FIGS. 10-12 depict a locking assembly according to an alternative preferred embodiment. As shown in FIGS. 10 and 11, locking assembly 100 includes backing bracket 134 having a generally T-shaped cross-section formed by a pair of coplanar support flanges or portions 144 (right 144a and left 144b as viewed exteriorly), and outer locking portion or flange 147 extending exteriorly and perpendicularly from between the pair of support flanges 144. Support flanges 144 are both provided with holes 124 near the opposite ends of backing bracket 134, through which fasteners 126 such as screws are inserted and threaded directly into dwelling 14 or, as shown, into internally threaded inserts 125 located in the exterior surface of the dwelling above header 19 and below sill 18.

To be locked, shutters 12 are first closed, portions of their now-interiorly facing surfaces proximal to their adjacent vertical edges abutting support flanges 144. The edge of outer locking flange 147 extends through shutter gap 48, as described above, presenting a portion of the flange that is to be received within the locking channel of the retention bracket.

Retention bracket 42 as described above is fitted over gap 48 and the projecting edge of outer locking flange or portion 147 extending beyond the exteriorly facing surfaces of shutters 12 near shutter gap 48 is received in channel 36. Aligned sets of holes 43, 45 are respectively provided in channel 36 and outer locking flange 147 as described above, and a fastener 56 is inserted in each set of aligned holes 43, 45 to retain and capture the portions of shutters disposed between support flanges 144 and retention flanges 38, 40, thereby locking the shutters into their closed position 13.

The invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that reference numerals are merely for convenience and are not to be in any way limiting, the invention may be practiced otherwise than as specifically described.

1. A locking assembly for retaining a pair of shutters in a closed position on a dwelling, said locking assembly comprising:
an elongate backing bracket adapted to be fixedly mounted to the dwelling, said backing bracket comprising a pair of support portions extending laterally relative to the length of said backing bracket, and an outer locking portion, the pair of shutters in their closed position in abutting contact with said support portions, said outer locking portion extending through a gap defined between adjacent edges of the closed pair of shutters;
an elongate retention bracket having a channel in which said outer locking portion is received, and a pair of retention portions extending laterally relative to the length of said retention bracket, said outer locking portion adapted to be secured to said retention bracket within said channel;
whereby the adjacent edges of the closed pair of shutters are captured between said support portions and said retention portions, retaining the pair of shutters in a closed position.

2. The locking assembly of claim 1, further comprising a pair of support legs adapted to be fixedly mounted to one of a sill and a header of an opening in the dwelling, a support gap being defined between said support legs, and wherein said backing bracket further comprises an inner locking portion opposed to said outer locking portion, said inner locking portion disposed between said support legs and releasably coupled thereto.

3. The locking assembly of claim 2, further comprising a base adapted to be fixedly mounted to one of a header and a sill of the dwelling opening, said base comprising said pair of support legs, and further comprising a foot including flanges laterally extending from said pair of support legs, mounting of said base to the sill or header being through said flanges.

4. The locking assembly of claim 3, wherein a said base is adapted to be fixedly mounted to both the header and the sill of the dwelling opening, said backing bracket adapted to have its opposite ends received within the support gaps of said bases, and extend between said bases.

5. The locking assembly of claim 2, wherein said support legs and said inner locking portion are adapted to have aligned apertures through which to receive a fastener.

6. The locking assembly of claim 5, wherein said fastener is a pin.

7. The locking assembly of claim 1, wherein said elongate backing bracket has a cross section that is substantially X-shaped, said pair of support portions being substantially coplanar flanges, said inner and outer locking portions being substantially coplanar flanges.

8. The locking assembly of claim 1, wherein said elongate retention bracket channel is substantially U-shaped, said channel having a pair of spaced walls, said retention portions comprising a pair of substantially coplanar flanges each joined to the end of one of said channel walls.

9. The locking assembly of claim 8, wherein said channel walls and said outer locking portion are adapted to have aligned apertures through which to receive a fastener when said locking assembly is locked, and the shutters are retained in their closed position.

10. The locking assembly of claim 9, wherein said fastener is a pin.

11. The locking assembly of claim 1, wherein said backing bracket is adapted to extend over an opening in the dwelling and be fixedly mounted to the dwelling above a header of the opening and below a sill of the opening.

12. The locking assembly of claim 11, wherein said support portions are adapted to receive fasteners therethrough for fixedly mounting said backing bracket to the dwelling.

13. The locking assembly of claim 1, wherein said elongate backing bracket has a cross section that is substantially T-shaped, said pair of support portions being substantially coplanar flanges, said outer locking portion being a flange extending perpendicularly therefrom.

14. A locking assembly for retaining a pair of shutters in a closed position over an opening of a dwelling, said locking assembly comprising:
a backing bracket having an exteriorly-directed outer locking flange and a pair of substantially coplanar support flanges, said outer locking flange extending perpendicularly from between said pair of support flanges, said outer locking flange extending through a gap between adjacent substantially vertical edges of the closed pair of shutters and projecting beyond the exterior, substantially vertical surfaces of the shutters proximal to the gap, said backing bracket being secured to the dwelling;
a retention bracket disposed over the gap and comprising a channel formed by a pair of spaced, substantially vertical walls, said walls being substantially parallel to each other, and a pair of substantially coplanar retention flanges, a said retention flange extending laterally outwardly from said channel from the end of each of the pair of channel walls, said support flanges and said retention flanges being substantially parallel when said locking assembly is locked, portions of the shutters proximal to the gap being captured between said support and retention flanges;
wherein the portion of said outer locking flange projecting beyond the exterior surfaces of the closed shutters is disposed within said channel.

15. The locking assembly of claim 14, wherein said retention bracket channel walls and said outer locking flange include a plurality of aligned holes, a fastener extending through said holes, whereby said backing bracket and said retention bracket are attached to each other.

16. The locking assembly of claim 14, wherein said backing bracket has a substantially T-shaped cross section, said support flanges being fixedly mounted to the dwelling.

17. The locking assembly of claim 16, wherein said support flanges are fixedly mounted to the dwelling at locations vertically above and below the shutters.

18. The locking assembly of claim 14, wherein said backing bracket has a substantially X-shaped cross section, and further comprising an inner locking flange substantially parallel with said outer locking flange, said inner locking flange located on the opposite side of said coplanar support flanges from said outer locking flange, said inner locking flange being releasably secured to the dwelling.

19. The locking assembly of claim 18, further comprising at least one base fixedly mounted to the dwelling, said inner locking flange being releasably secured to said base.

20. The locking assembly of claim 19, wherein said inner locking flange is adapted to be disconnected from said base at a location accessible from the interior of the dwelling, whereby the pair of shutters, with said backing bracket and said retention bracket remaining connected together, may be moved from its closed to its open position to permit egress from the dwelling through the opening.
